(19) United States
(12) Patent Application Publication
(10) Pub. No.: US 2014/0144955 A1
(43) Pub. Date: May 29, 2014

(54) Writing Instrument Tether

(71) Applicant: Tammy Maria Spruill, Saint Charles, MO (US)

(72) Inventor: Tammy Maria Spruill, Saint Charles, MO (US)

(21) Appl. No.: 14/077,341

(22) Filed: Nov. 12, 2013

Related U.S. Application Data
(60) Provisional application No. 61/727,310, filed on Nov. 16, 2012.

(51) Int. Cl. B43K 23/02

(52) U.S. Cl. CPC B43K 23/02
USPC 224/255

(57) ABSTRACT

Writing Instrument tether that includes but not limited to attachment to the inside zipper of purses, handbags and backpacks. Writing Instrument tether is an instrument that can have different designs and uses. Attaching tether to inside zipper of purse allows easy access to writing pen. Writing instrument tether allows one to detach pen as well as attach other objects including but not limited to lighter, lip gloss, small flashlight, and car keys.

### CROSS-RELATED REFERENCE TEXT

This application claims priority to provisional application No. 61727310 filed Nov. 16, 2012 as a conversion of a provisional application to a non provisional application.

### FIELD OF THE INVENTION

The present invention relates to tethers, and more particularly to leashed writing instrument and purse which are intended for use for everyday activities such as going to work or shopping. By using this invention, it prevents the inadvertent loss of writing instruments.

### BACKGROUND OF THE INVENTION

All people have the need for writing instruments such as pens, pencils, or mechanical pencils. Whether it relates to taking notes, filling out a checkbook, or even filling out forms, there is an undeniable need for pens. A problem arises when there is a need for a pen but there are none to be found. A lot of times pens get lost in the car or in various places in the home and office.

The need for a writing instrument is none more evident when one is out of the house running errands. There are many times when one is standing in line at the bank and there isn't a pen to be found. There is another instance when standing in line at the post office and there are no pens to fill out certain forms while waiting in line. There exists a need for an inexpensive way to prevent the loss of writing instruments.

### SUMMARY OF THE INVENTION

The present invention addresses the above stated need by providing an inexpensive and practical solution to losing pens.

The tether provides a chain that is linked to a purse on one end and at the other end is a writing instrument like a pen. The tether may take the form of a chain that is connected to the purse. The tether may also take the form of a retractable device such as winding coil that is connected to the chain.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a front view of the invention;

FIG. 2 is a front view of an alternative embodiment of the invention;

FIG. 3 is a front view of a further alternative embodiment of the invention; and

FIG. 4 is a perspective view of a further embodiment utilizing a retractable tether.

### DETAILED DESCRIPTION

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

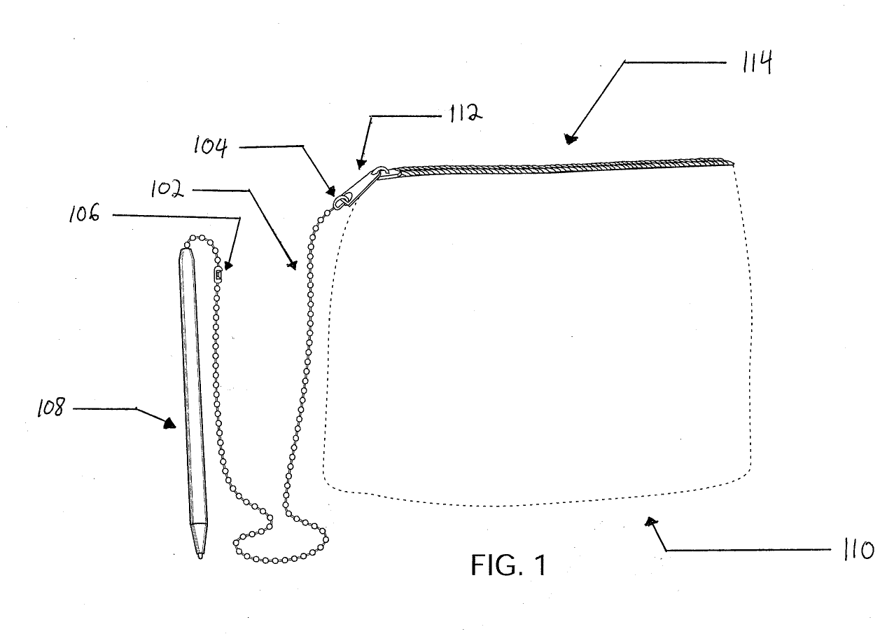

As illustrated in FIG. 1, the zipper 114 allows the purse 110 to open or close up so that the content of the purse 110 doesn't fall out. The zipper tab 112 provides the user a strip to hold on to in order to open or close the zipper 114. The loop 104 provides a mechanism for the tether 102 to be attached. As a non-limiting example, the tether may be a metal chain that is interlinked with small ball-like pieces.

The tether 102, due to the interlinked nature, is able to move freely. This allows the user to move the writing instrument 108 in any direction and is only limited by the length of the tether 102. Despite the freedom of movement, the tether 102 has the strength of the material which it is made. The writing instrument 108 is connected to the tether 102 by a hooking device 106. This hooking device 106 allows the writing instrument to be connected to the tether 102. Moreover, the hooking device 106 is able to unhook the tether 102 from the writing instrument 108.

The tether 102 has a first end which is attached to the purse 110 by the means of a loop 104. The loop 104 may be as simple as a piece of metal that is bent in a circular shape that encloses so that the zipper tab 112 is connected to the tether 102. At the opposite end of the tether 102, the second end is attached to the writing instrument 108 by the means of a hooking device 106. The hooking device 106 is able to connect the tether 102 to the writing instrument 108 by hooking one link of the tether to the link of the writing instrument 108.

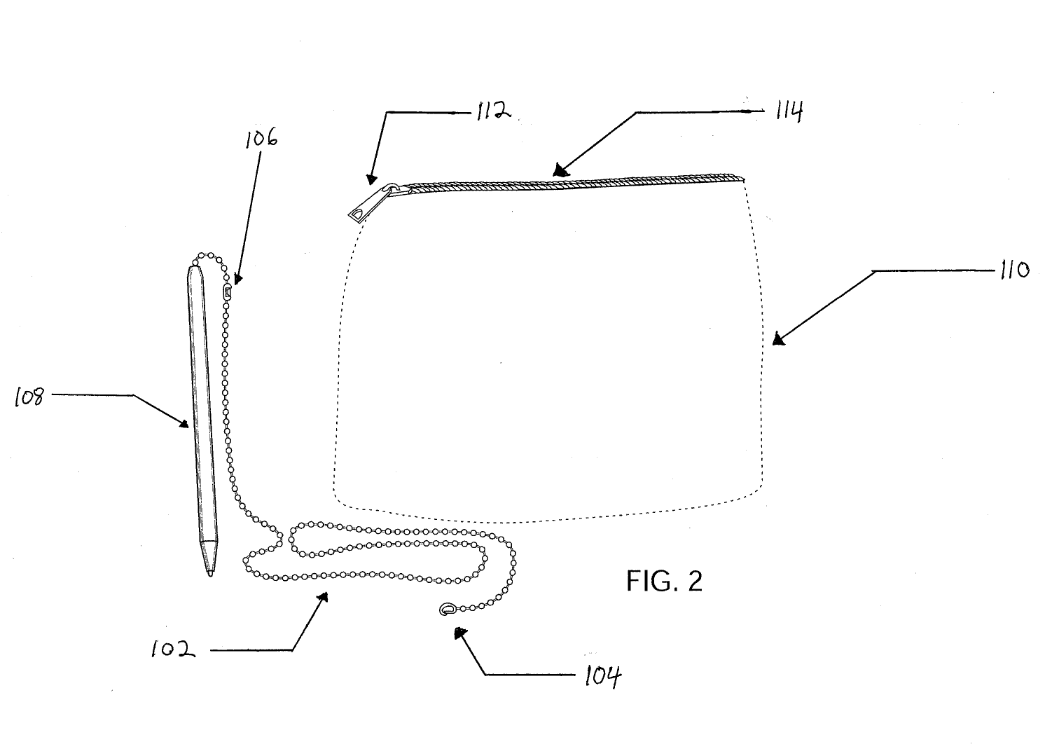

As illustrated in FIG. 2, the loop 104 is unattached to the zipper tab 112. This allows the purse 110 to unattached to the tether 102 and may be cleaned. As a nonlimiting example, the tether may be changed out for another tether 102 with a different design or color.

As non-limiting examples, the writing instrument 108 may be a pen, pencil, marker, or highlighter. The writing instrument 108 may receive ink from an ink cartridge. The ink cartridge would provide the necessary ink in order for the writing instrument 108 to write notes or messages. The ink cartridge may come in different colors like black, blue, or red.

The loop 104 may be unattached to the zipper tab 112. As a non-limiting example, the loop 104 may be a pliable piece of metal. This would allow the loop 104 to be closed with the force of a wrench and would prevent the tether 102 from being unattached. This loop 104 would allow the tether 102 to be changed out or provide a mechanism for the tether 102 to be attached to the purse 110.

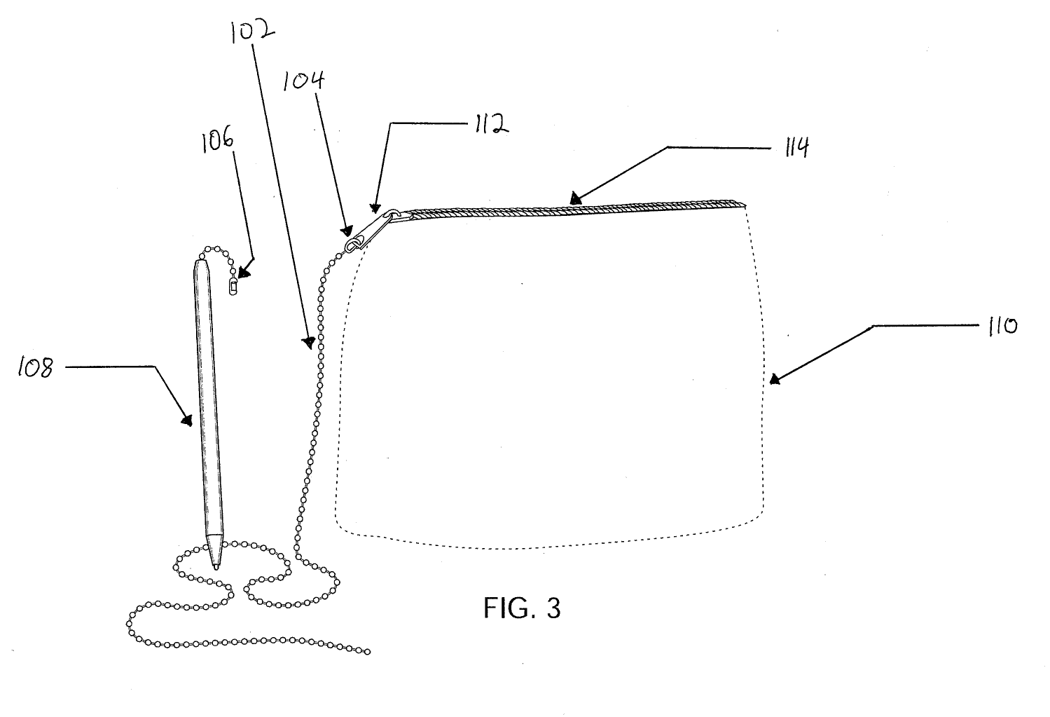

As further illustrated in FIG. 3, the tether 102 is unattached to the hooking device 106. This would allow the writing instrument 108 to be unattached to the tether 102. Accordingly, the writing instrument 108 may be exchanged for another writing instrument 108 with a different design or color. The hooking device 106 may be made with a metal piece that has two enclosed hooks that would hook to an individual link of the tether 102.

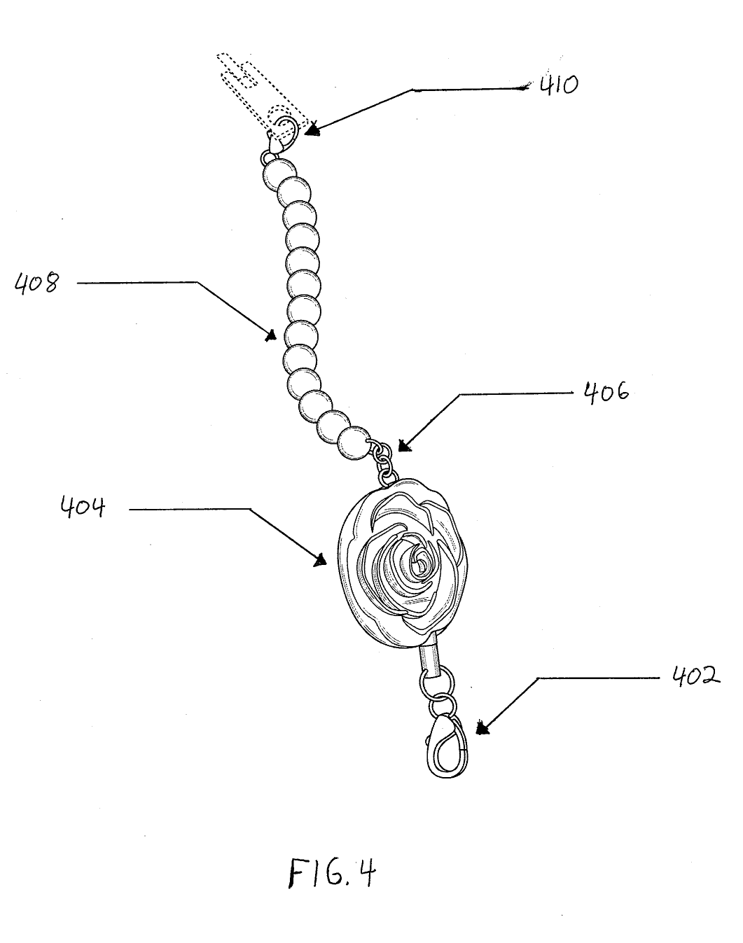

As illustrated in FIG. 4, the retractable tether 408 may be retractable. This would allow the retractable tether 408 to have a variable length that is determined by the tension of the wound retractable coil.

The casing 404 would have an internal wound retractable coil. As a non-limiting example the coil may be made of a metal, once wound, would provide tension. This tension would allow the retractable tether 404 to retract. One end of the coil is attached inside the casing 404. This end of the coil would be attached within the casing 404 and would anchor the coil. The opposite end of the coil 406 would extend outside of the casing 404. This end of the coil 406 would pull the coil outside of the casing 404 which the other end of the coil is still anchored inside the casing 404.

The chain 408 has a first end which is connected to the end of the coil 406. The length of the chain 408 is already determined and would not vary. However, the coil would allow the chain 408, along with the end of the coil 406 to extend. This would allow the user to have more freedom to use the writing instrument 108 from a longer distance from the purse 110.

At the opposite end of the chain 408 from the coil 406, is a clip 410. The clip 410 has a fasting mechanism and it may be a hook and loop fastener. This would allow the user to clip the chain 408 to the purse 110 or conversely to a writing instrument 108. On the other side of the casing 404, there may be a second chain that is attached to a clip 402. This clip 402 has a fasting mechanism and it may be a hook and loop fastener.

As a non-limiting example, the casing 404 may have an external design of that of a flower or other floral design. Moreover, the casing 404 may be made of metal, plastic, or some other type of polyurethane material.

In addition, the retractable tether may be used not only to attach a writing instrument 108 to a purse 110 but may also be used to attach a bag to a portable music device. Other non-limiting examples would include attaching glasses to a backpack or attaching a wallet to an article of clothing.

1. Writing Instrument tether that comprises of metal loop that attaches to inside zipper of purse.

2. Writing Instrument according to claim 1 wherein Instrument that comprises of a piece of metal that is bent in a circular shape that encloses so that easily attaches to inside zippers.

3. Apparatus according to claim 1 that comprises of unlimited designs wherein allows the detachment and attachment of unlimited objects.
